(19) United States
(12) Patent Application Publication
(10) Pub. No.: US 2026/0336237 A1
(43) Pub. Date: Oct. 29, 2026

(54) VACUUM COMPACTOR AND METHODS OF USE

(71) Applicant: The Boeing Company, Arlington, VA (US)

(72) Inventor: Luis F. Velasquez, Ladson, SC (US)

(21) Appl. No.: 19/187,737

(22) Filed: Apr. 23, 2025

(51) Int. Cl. B29C 70/54; B25J 15/06; B29C 31/08

(52) U.S. Cl. CPC B29C 70/541; B25J 15/0616; B29C 31/08

(57) ABSTRACT

A vacuum compactor and methods of use are presented. A vacuum compactor configured to pick and place composite members of different cross-sections comprises a vacuum control module, a number of releasable connectors associated with the vacuum control module actuable by an end effector comprising the vacuum control module, and a stringer interface module having a contact surface shape complementary to a composite member, configured to pick, place, and compress the composite member, and removably connectable to the vacuum control module by an end effector using the number of releasable connectors.

### BACKGROUND INFORMATION

### 1. Field

The present disclosure relates generally to composite manufacturing and more specifically to a vacuum compactor and its use in composite manufacturing.

### 2.Background:

A preform for a composite part may be incapable of supporting itself when placed onto a sloped surface of a tool. In particular, placement of large preforms onto rigid tooling that exhibits a complex curvature can be complicated. This is because large preforms have an increased chance of peeling or shifting from tooling during or after placement. If the preforms are not quickly and firmly compacted onto a tool, then peeling may occur. Thus, it remains desirable to quickly and effectively move and secure preforms (and/or other objects) to complex surfaces.

Therefore, it would be desirable to have a method and apparatus that takes into account at least some of the issues discussed above, as well as other possible issues.

### SUMMARY

An embodiment of the present disclosure provides a method of picking a composite member. A cross-sectional shape of a composite member to be placed onto a forming tool is determined. A stringer interface module compatible with the cross-sectional shape of the composite member is selected based on the cross-sectional shape of the composite member. The stringer interface module is automatically coupled to a vacuum control module of an end effector. The stringer interface module is engaged with the composite member.

Another embodiment of the present disclosure provides a method of placing a composite member. A stringer interface module is automatically coupled to a vacuum control module of an end effector. A composite member is placed in contact with a forming surface of a forming tool using the end effector while sending vacuum through the vacuum control module to a first region of the stringer interface module. The composite member is compacted against the forming tool by sending vacuum through the vacuum control module to a second region of the stringer interface module. The stringer interface module is automatically removed from the vacuum control module after compacting the composite member against the forming tool.

Yet another embodiment of the present disclosure provides a vacuum compactor configured to pick and place composite members of different cross-sections. The vacuum compactor comprises a vacuum control module; a number of releasable connectors associated with the vacuum control module actuatable by an end effector comprising the vacuum control module; and a stringer interface module having a contact surface shape complementary to a composite member, configured to pick, place, and compress the composite member, and removably connectable to the vacuum control module by an end effector and using the number of releasable connectors.

Yet another embodiment of the present disclosure provides a method of configuring an end effector. A stringer interface module to mate with a composite member having a cross-sectional shape is determined. The stringer interface module is automatically coupled to a vacuum control module of the end effector.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of a vacuum compactor in accordance with an illustrative embodiment;

FIG. 4 is an illustration of an isometric view of a vacuum control module moving towards a stringer interface module in accordance with an illustrative embodiment;

FIG. 5 is an illustration of a cross-sectional view of a vacuum compactor in accordance with an illustrative embodiment;

FIGS. 6A and 6B are a flowchart of a method of picking up a composite member in accordance with an illustrative embodiment;

FIG. 7 is a flowchart of a method of placing a composite member in accordance with an illustrative embodiment;

FIG. 8 is a flowchart of a method of configuring an end effector in accordance with an illustrative embodiment;

FIG. 9 is an illustration of an aircraft manufacturing and service method in a form of a block diagram in accordance with an illustrative embodiment; and

FIG. 10 is an illustration of an aircraft in a form of a block diagram in which an illustrative embodiment may be implemented.

### DETAILED DESCRIPTION

The illustrative examples recognize and take into account one or more different considerations. The illustrative examples provide high volume vacuum systems that quickly and effectively pick and place objects such as preforms onto complex surfaces and that compact the objects into place via vacuum. The illustrative examples utilize two-phase vacuum systems which operate a first portion to generate a suction hold for carrying an object to a tool and operate a second portion to generate a suction hold that compacts the object onto the tool. Compaction ensures that the object remains secured to the tool, regardless of the orientation of the tool.

The illustrative examples recognize and take into account that after placement using pick and place and compaction end effectors, the vacuum is shut off, but the retraction of the end effector away from the mandrel can work to facilitate a vacuum gripping. A vacuum gripping during retraction can pull the placed ply out of the desired location (shifting/disbonding). The illustrative examples provide a vacuum system end effector that enables a compacted stringer to stay in place better than the current stringer placement.

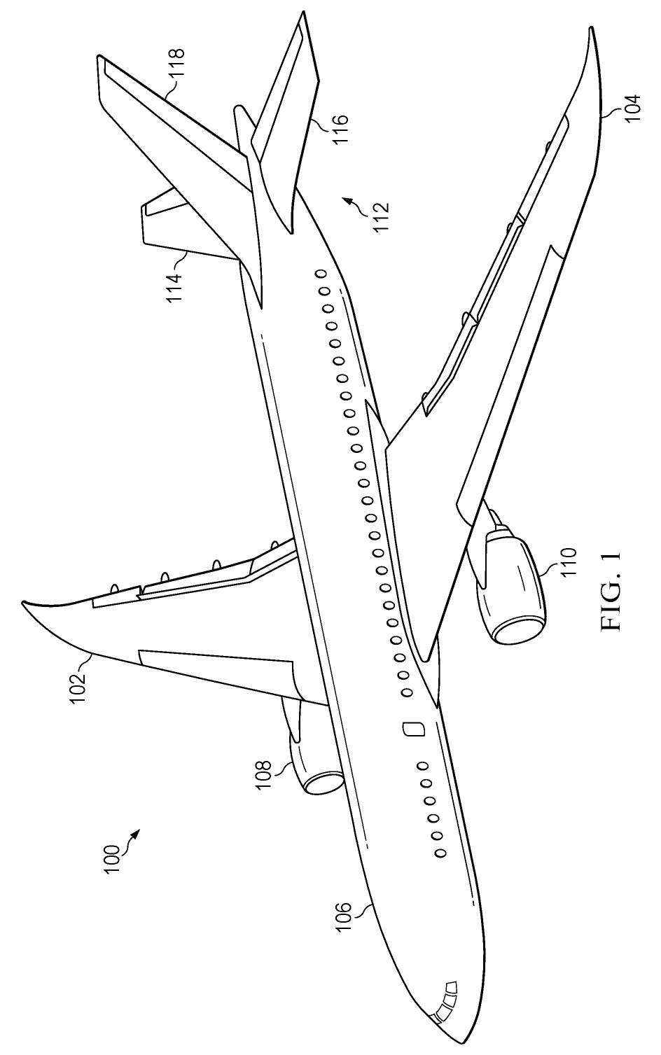

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have composite structures compacted using a vacuum compactor of the illustrative examples. In some illustrative examples, a composite stringer of wing 102, wing 104, or body 106 of aircraft 100 can be compacted using the methods of the illustrative examples.

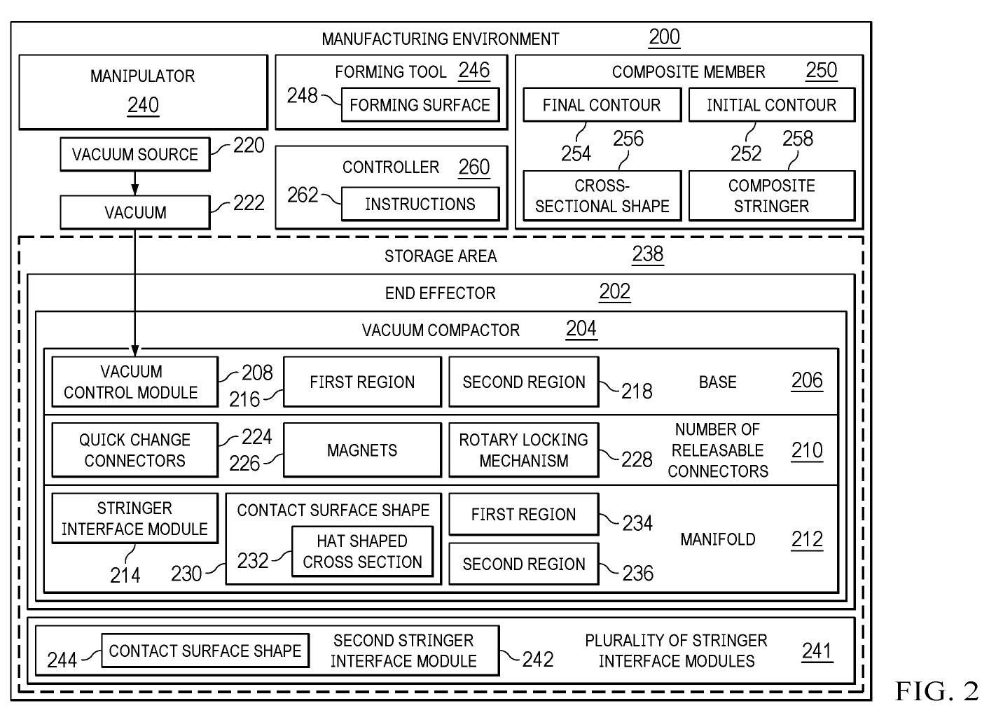

Turning now to FIG. 2, an illustration of a block diagram of a manufacturing environment is depicted in accordance with an illustrative embodiment. Composite member 250 of FIG. 2 can be a composite structure of aircraft 100 of FIG. 1.

Composite member 250 can be picked and placed onto forming surface 248 of forming tool 246 using end effector 202. End effector 202 can compact composite member 250 against forming tool 246. By forming and compacting composite member 250 to forming surface 248 of forming tool 246, the contour of composite member 250 changes from initial contour 252 to final contour 254. In some illustrative examples, composite member 250 takes the form of composite stringer 258. Composite member 250 has cross-sectional shape 256. Cross-sectional shape 256 of composite member 250 is maintained throughout forming and compacting using end effector 202.

End effector 202 comprises vacuum compactor 204. Base 206 remains connected to end effector 202. Base 206 can also be referred to as vacuum control module 208.

Manifold 212 is removably connected to base 206. Manifold 212 can also be referred to as stringer interface module 214.

Vacuum compactor 204 is configured to pick and place composite member 250 and other composite members having different cross-sections. Vacuum compactor 204 comprises vacuum control module 208, number of releasable connectors 210 associated with vacuum control module 208 actuatable by end effector 202 comprising vacuum control module 208, and stringer interface module 214 having contact surface shape 230 complementary to composite member 250, configured to pick, place, and compress composite member 250, and configured to be coupled to and removed from vacuum control module 208 by end effector 202 and using number of releasable connectors 210. Vacuum compactor 204 comprises vacuum control module 208, number of releasable connectors 210 associated with vacuum control module 208 actuable by end effector 202 comprising vacuum control module 208, and stringer interface module 214 having contact surface shape 230 complementary to composite member 250, configured to pick, place, and compress composite member 250, and removably connectable to vacuum control module 208 by end effector 202 and using number of releasable connectors 210.

In this illustrative example, vacuum control module 208 comprises first region 216 and second region 218 controllable to provide vacuum to different regions of stringer interface module 214.

In some illustrative examples, stringer interface module 214 comprises first region 234 configured to lift composite member 250, and second region 236 configured to compact composite member 250. In this illustrative example, contact surface shape 230 is configured to be complementary to cross-sectional shape 256. In some illustrative examples, contact surface shape 230 is complementary to composite member 250 having hat-shaped cross-section 232.

Second stringer interface module 242 can be coupled to vacuum control module 208 when stringer interface module 214 is decoupled from vacuum control module 208. Second stringer interface module 242 has contact surface shape 244 different from contact surface shape 230. Contact surface shape 244 is configured to be complementary to a composite member having a different cross-sectional shape from cross-sectional shape 256.

Number of releasable connectors 210 comprises any desirable type of connector. In some illustrative examples, number of releasable connectors 210 comprises at least one of quick change connectors 224, magnets 226, or rotary locking mechanism 228. In some illustrative examples, stringer interface module 214 is coupled to vacuum control module 208 by vacuum.

Vacuum 222 is provided to at least one of first region 234 or second region 236 of stringer interface module 214 by vacuum control module 208. Vacuum control module 208 is provided vacuum 222 from vacuum source 220. End effector 202 can be moved within manufacturing environment 200 by manipulator 240. In some illustrative examples, manipulator 240 takes the form of a collaborative robot.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, more than two stringer interface modules can be present in storage area 238. In another illustrative example, stringer interface module 214 can have a different surface shape than hat shaped cross-section 232.

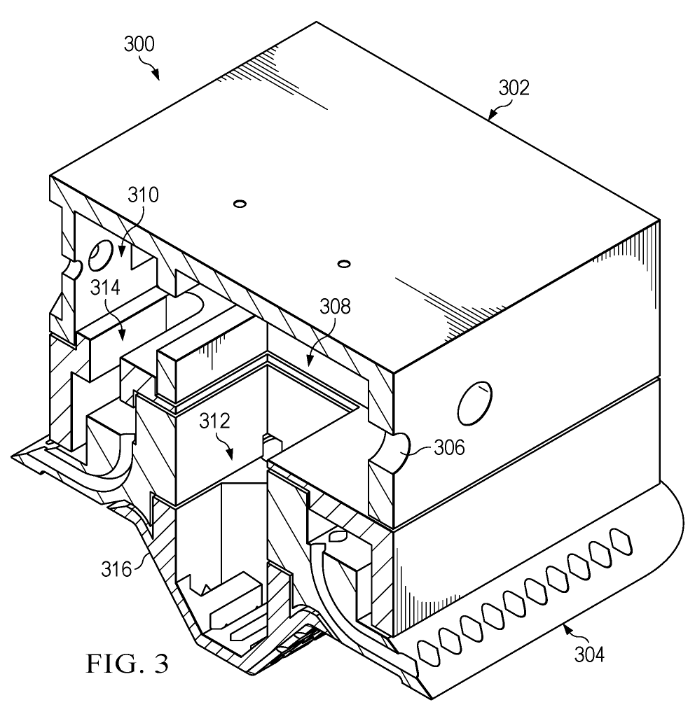

Turning now to FIG. 3, an illustration of a cross-sectional view of a vacuum compactor is depicted in accordance with an illustrative embodiment. Vacuum compactor 300 can be a physical implementation of vacuum compactor 204 of FIG. 2.

Vacuum compactor 300 is configured to pick and place composite members of different cross-sections. Vacuum compactor 300 comprises vacuum control module 302 and stringer interface module 304. Stringer interface module 304 has contact surface shape 316 complementary to a composite member, configured to place and compress the composite member, and removably connectable to vacuum control module 302 by an end effector and using the number of releasable connectors. In this illustrative example, contact surface shape 316 is complementary to a composite member having a hat-shaped cross-section. In this illustrative example, a number of releasable connectors (not depicted) is associated with vacuum control module 302 and is actuatable by an end effector comprising vacuum control module 302. In some illustrative examples, the number of releasable connectors comprises at least one of quick change connectors, magnets, or a rotary locking mechanism. In some illustrative examples, stringer interface module 304 can be connected to vacuum control module 302 by vacuum.

Vacuum control module 302 comprises first region 308 and second region 310 controllable to provide vacuum to different regions of stringer interface module 304. In this illustrative example, a vacuum source can provide vacuum to vacuum control module 302 via vacuum portion 306. Vacuum can be selectively controlled to first region 308 and second region 310 by actuating portions of vacuum control module 302. Stringer interface module 304 comprises first region 312 configured to lift a composite member, and second region 314 configured to compact the composite member.

In this illustrative example, stringer interface module 304 comprises a raised face for an inlet of second region 314. In this illustrative example, the raised face can be used for indexing. In this illustrative example, the raised face can be used to connect second region 310 to second region 314.

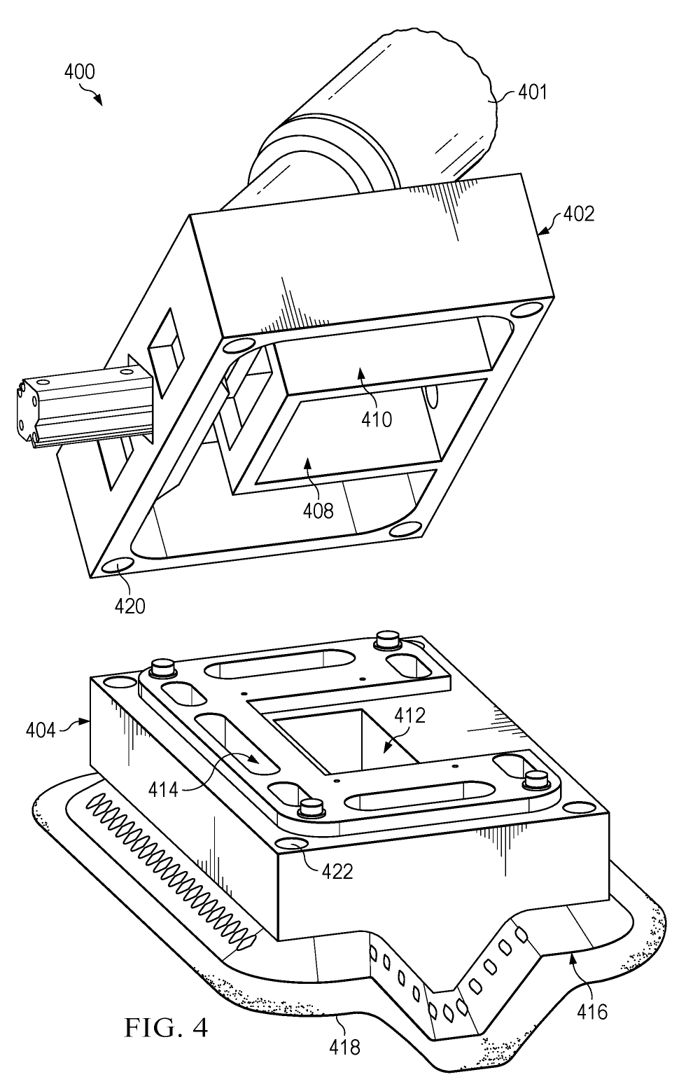

Turning now to FIG. 4, an illustration of an isometric view of a vacuum control module moving towards a stringer interface module is depicted in accordance with an illustrative embodiment. Vacuum compactor 400 can be a physical implementation of vacuum compactor 204 of FIG. 2. In some illustrative examples, vacuum control module 402 is the same as vacuum control module 302 of FIG. 3. In some illustrative examples, stringer interface module 404 is the same as stringer interface module 304 of FIG. 3.

Vacuum compactor 400 is configured to pick and place composite members of different cross-sections. Vacuum compactor 400 comprises vacuum control module 402 and stringer interface module 404. In this illustrative example, vacuum control module 402 is connected to manipulator 401. In this illustrative example, manipulator 401 takes the form of a collaborative robot. Vacuum compactor 400 is an end effector configured to pick, place, and compact a composite member.

Stringer interface module 404 has contact surface shape 416 complementary to a composite member. Vacuum compactor 400 is configured to place and compress the composite member. Stringer interface module 404 is removably connectable to vacuum control module 402 by the end effector and using a number of releasable connectors. In this illustrative example, contact surface shape 416 is complementary to a composite member having a hat-shaped cross-section. In this illustrative example, number of releasable connectors 420 is associated with vacuum control module 402 and is actuatable by an end effector comprising vacuum control module 402. In this illustrative example, number of releasable connectors 420 comprises magnets associated with vacuum control module 402. In this illustrative examples, number of releasable connectors 420 is configured to connect to number of releasable connectors 422 in stringer interface module 404. In this illustrative example, number of releasable connectors 422 comprises magnets.

In some illustrative examples, the number of releasable connectors comprises at least one of quick change connectors, magnets, or a rotary locking mechanism. In some illustrative examples, stringer interface module 404 can be connected to vacuum control module 402 by vacuum.

Vacuum control module 402 comprises first region 408 and second region 410 controllable to provide vacuum to different regions of stringer interface module 404. In this illustrative example, a vacuum source can provide vacuum to vacuum control module 402 via a vacuum port. Vacuum can be selectively controlled to first region 408 and second region 410 by actuating portions of vacuum control module 402. Stringer interface module 404 comprises first region 412 configured to lift a composite member and second region 414 configured to compact the composite member.

In this illustrative example, stringer interface module 404 comprises a raised face for an inlet of second region 414. In this illustrative example, the raised face can be used for indexing. In this illustrative example, the raised face can be used to connect second region 410 to second region 414.

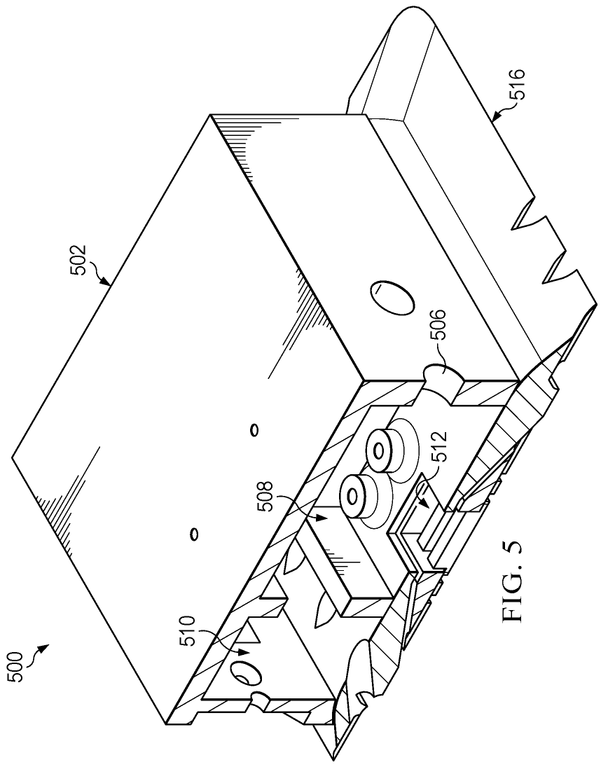

Turning now to FIG. 5, an illustration of a cross-sectional view of a vacuum compactor is depicted in accordance with an illustrative embodiment. Vacuum compactor 500 can be a physical implementation of vacuum compactor 204 of FIG. 2. In some illustrative examples, vacuum control module 502 is the same as vacuum control module 302 of FIG. 3. In some illustrative examples, vacuum control module 502 can be the same as vacuum control module 402 of FIG. 4.

Vacuum compactor 500 is configured to pick and place composite members of different cross-sections. Vacuum compactor 500 comprises vacuum control module 502 and stringer interface module 504. Stringer interface module 504 has contact surface shape 516 complementary to a composite member, configured to place and compress the composite member, and removably connectable to vacuum control module 502 by an end effector using the number of releasable connectors. In this illustrative example, contact surface shape 516 is complementary to a composite member having a flat surface. In this illustrative example, a number of releasable connectors (not depicted) is associated with vacuum control module 502 and is actuatable by an end effector comprising vacuum control module 502. In some illustrative examples, the number of releasable connectors comprises at least one of quick change connectors, magnets, or a rotary locking mechanism. In some illustrative examples, stringer interface module 504 can be connected to vacuum control module 502 by vacuum.

Vacuum control module 502 comprises first region 508 and second region 510 controllable to provide vacuum to different regions of stringer interface module 504. In this illustrative example, a vacuum source can provide vacuum to vacuum control module 502 via vacuum portion 506. Vacuum can be selectively controlled to first region 508 and second region 510 by actuating portions of vacuum control module 502. Stringer interface module 504 comprises first region 512 configured to lift a composite member, and second region 514 configured to compact the composite member.

In this illustrative example, stringer interface module 504 comprises a raised face for an inlet of second region 514. In this illustrative example, the raised face can be used for indexing. In this illustrative example, the raised face can be used to connect second region 510 to second region 514.

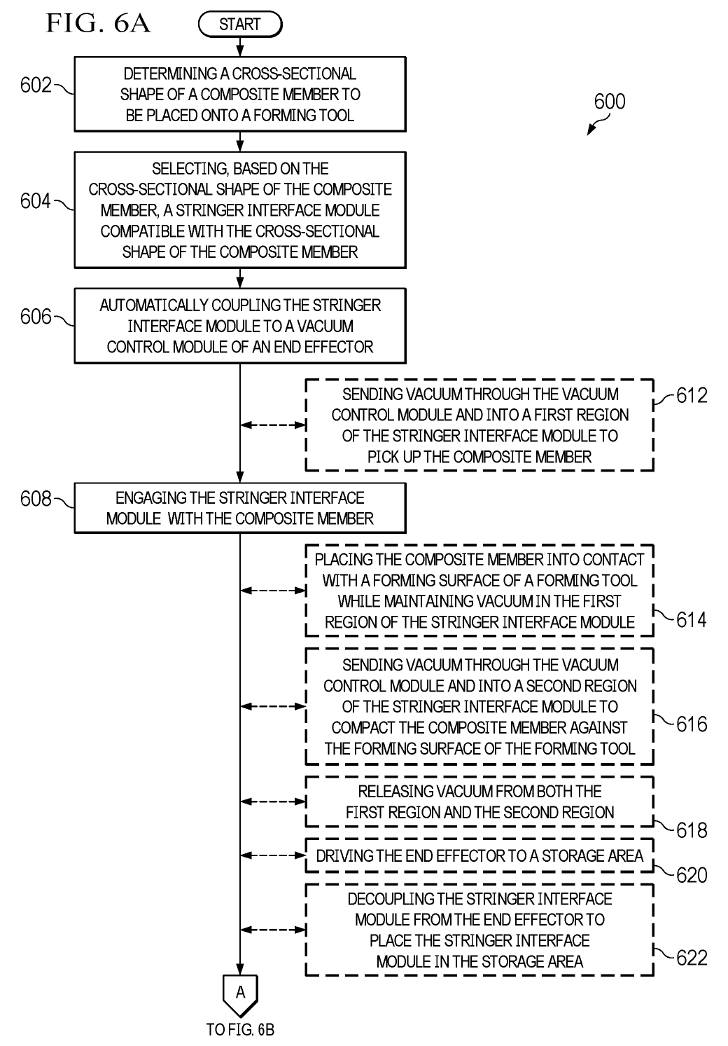

Turning now to FIGS. 6A and 6B, a flowchart of a method of picking up a composite member is depicted in accordance with an illustrative embodiment. Method 600 can be performed using vacuum control module 208 and stringer interface module 214 of FIG. 2. Method 600 can be performed using vacuum control module 302 and stringer interface module 304 of FIG. 3. Method 600 can be performed using vacuum control module 402 and stringer interface module 404 of FIG. 4. Method 600 can be performed using vacuum control module 502 and stringer interface module 504 of FIG. 5.

Method 600 determines a cross-sectional shape of a composite member to be placed onto a forming tool (operation 602). Method 600 selects, based on the cross-sectional shape of the composite member, a stringer interface module compatible with the cross-sectional shape of the composite member (operation 604). Method 600 automatically couples the stringer interface module to a vacuum control module of an end effector (operation 606). Method 600 engages the stringer interface module with the composite member (operation 608). Afterwards, method 600 terminates.

In some illustrative examples, method 600 sends vacuum through the vacuum control module and into a first region of the stringer interface module to pick up the composite member (operation 612). In some illustrative examples, method 600 places the composite member into contact with a forming surface of a forming tool while maintaining vacuum in the first region of the stringer interface module (operation 614).

In some illustrative examples, method 600 sends vacuum through the vacuum control module and into a second region of the stringer interface module to compact the composite member against the forming surface of the forming tool (operation 616).

In some illustrative examples, method 600 releases vacuum from both the first region and the second region (operation 618). The vacuum can be released from the first region and the second region after placing and compacting the composite member using a vacuum compactor comprising the vacuum control module and the stringer interface module.

In some illustrative examples, method 600 drives the end effector to a storage area (operation 620). In some illustrative examples, method 600 decouples the stringer interface module from the end effector to place the stringer interface module in the storage area (operation 622). In some illustrative examples, method 600 decouples the stringer interface module from the end effector after performing a pick and place operation using the stringer interface module (operation 624). In some illustrative examples, method 600 automatically couples a second-stringer interface module having a different contact surface shape than the stringer interface module to the vacuum control module of the end effector (operation 626).

In some illustrative examples, automatically coupling the stringer interface module to the vacuum control module comprises coupling using quick change connectors (operation 628). In some illustrative examples, automatically coupling the stringer interface module to the vacuum control module comprises magnetically coupling the stringer interface module to the vacuum control module (operation 630). In some illustrative examples, automatically coupling the stringer interface module to the vacuum control module comprises controlling a rotary locking mechanism by the end effector to couple the stringer interface module to the vacuum control module (operation 632). In some illustrative examples, automatically coupling the stringer interface module to the vacuum control module comprises coupling the stringer interface module to the vacuum control module using vacuum. In some illustrative examples, an additional vacuum source is used to couple the vacuum control module to the stringer interface module.

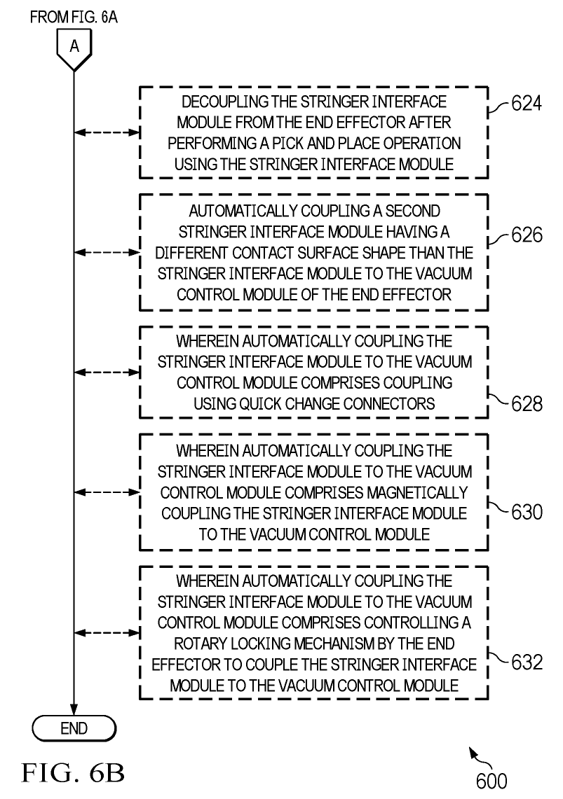

Turning now to FIG. 7, a flowchart of a method of placing a composite member is depicted in accordance with an illustrative embodiment. Method 700 can be performed using vacuum control module 208 and stringer interface module 214 of FIG. 2. Method 700 can be performed using vacuum control module 302 and stringer interface module 304 of FIG. 3. Method 700 can be performed using vacuum control module 402 and stringer interface module 404 of FIG. 4. Method 700 can be performed using vacuum control module 502 and stringer interface module 504 of FIG. 5.

Method 700 automatically couples a stringer interface module to a vacuum control module of an end effector (operation 702). Method 700 places a composite member in contact with a forming surface of a forming tool using the end effector while sending vacuum through the vacuum control module to a first region of the stringer interface module (operation 704). Method 700 compacts the composite member against the forming tool by sending vacuum through the vacuum control module to a second region of the stringer interface module (operation 706). Method 700 automatically removes the stringer interface module from the vacuum control module after compacting the composite member against the forming tool (operation 708). Afterwards, method 700 terminates.

In some illustrative examples, method 700 automatically couples a second stringer interface module having a different contact surface shape than the stringer interface module to the vacuum control module of the end effector (operation 710). In some illustrative examples, automatically coupling the stringer interface module to the vacuum control module comprises coupling the stringer interface module to the vacuum control module using vacuum. In some illustrative examples, an additional vacuum source is used to couple the vacuum control module to the stringer interface module.

In some illustrative examples, automatically coupling the stringer interface module to the vacuum control module comprises coupling using quick change connectors (operation 712). In some illustrative examples, automatically coupling the stringer interface module to the vacuum control module comprises magnetically coupling the stringer interface module to the vacuum control module (operation 714). In some illustrative examples, automatically coupling the stringer interface module to the vacuum control module comprises controlling a rotary locking mechanism by the end effector to couple the stringer interface module to the vacuum control module (operation 716).

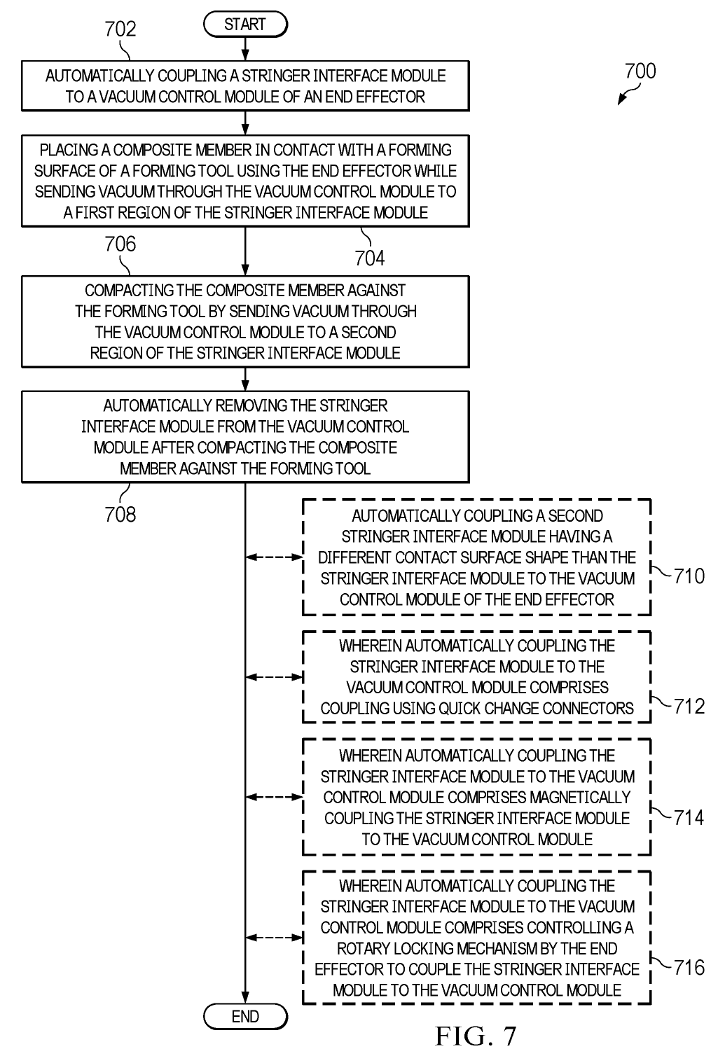

Turning now to FIG. 8, a flowchart of a method of configuring an end effector is depicted in accordance with an illustrative embodiment. Method 800 can be performed using vacuum control module 208 and stringer interface module 214 of FIG. 2. Method 800 can be performed using vacuum control module 302 and stringer interface module 304 of FIG. 3. Method 800 can be performed using vacuum control module 402 and stringer interface module 404 of FIG. 4. Method 800 can be performed using vacuum control module 502 and stringer interface module 504 of FIG. 5.

Method 800 determines a stringer interface module to mate with a composite member having a cross-sectional shape (operation 802). Method 800 automatically couples the stringer interface module to a vacuum control module of the end effector (operation 804). Afterwards, method 800 terminates.

In some illustrative examples, method 800 selects the stringer interface module from a plurality of stringer interface modules having varied contact surface shapes (operation 806).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 612 through operation 632 may be optional. For example, operation 710 through operation 716 may be optional.

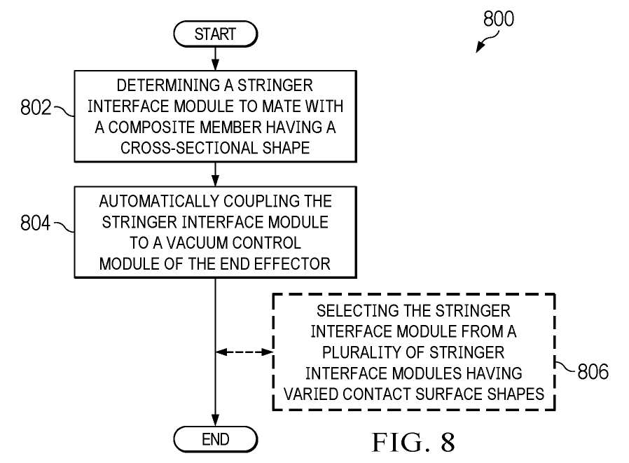

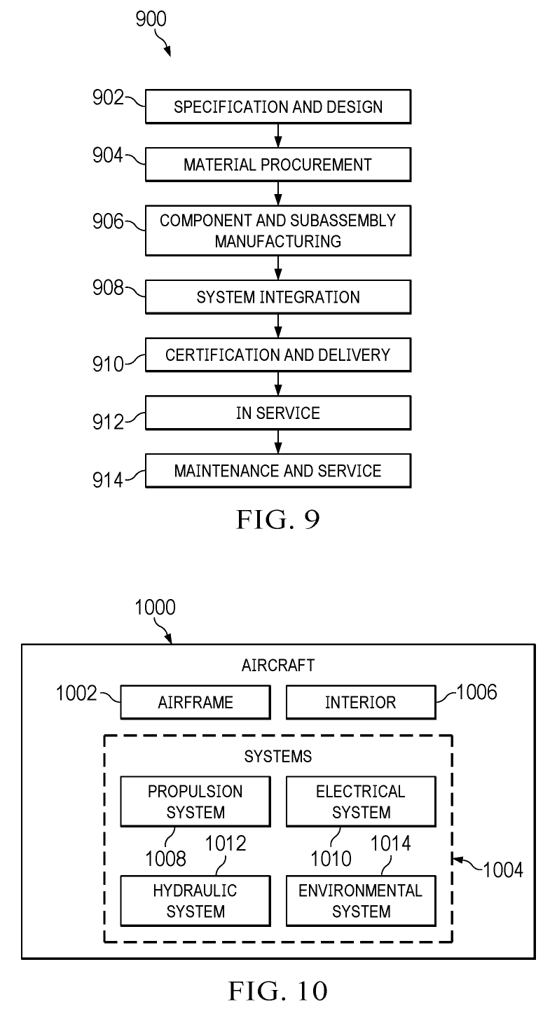

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in a form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

The illustrative examples provide an end effector design to enable the automated swapping of vacuum pick/compact tools used for different stringer types/shapes. An end effector of the illustrative examples comprises a permanent vacuum control module and interchangeable stringer interface modules.

The illustrative examples provide an end effector design to enable the automated swapping of vacuum pick/compact tools used for different stringer types/shapes. The illustrative examples comprise a locking mechanism between the permanent vacuum control module and an interchangeable stringer interface modules. In some illustrative examples, a locking mechanism comprises a magnet system or other locking mechanism. In some illustrative examples, a toolbox or other storage area comprises various interchangeable stringer interface modules.

The illustrative examples are configured to enable handling multiple stringer types. The illustrative examples provide an end effector with multiple stringer interface module designs that can interface with various stringers. The illustrative examples provide a vacuum control module designed to be permanently attached to an end effector mount. The illustrative examples provide stringer interface modules specific to respective stringer types designed to be able to be swapped in an automated manner.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of picking a composite member comprising:
determining a cross-sectional shape of a composite member to be placed onto a forming tool;
selecting, based on the cross-sectional shape of the composite member, a stringer interface module compatible with the cross-sectional shape of the composite member;
automatically coupling the stringer interface module to a vacuum control module of an end effector; and
engaging the stringer interface module with the composite member.

2. The method of claim 1, further comprising:
sending vacuum through the vacuum control module and into a first region of the stringer interface module to pick up the composite member.

3. The method of claim 2, further comprising:
placing the composite member into contact with a forming surface of a forming tool while maintaining vacuum in the first region of the stringer interface module.

4. The method of claim 3, further comprising:
sending vacuum through the vacuum control module and into a second region of the stringer interface module to compact the composite member against the forming surface of the forming tool.

5. The method of claim 4, further comprising:
releasing vacuum from both the first region and the second region;
driving the end effector to a storage area; and
decoupling the stringer interface module from the end effector to place the stringer interface module in the storage area.

6. The method of claim 1, further comprising:
decoupling the stringer interface module from the end effector after performing a pick and place operation using the stringer interface module; and
automatically coupling a second stringer interface module having a different contact surface shape than the stringer interface module to the vacuum control module of the end effector.

7. The method of claim 1, wherein automatically coupling the stringer interface module to the vacuum control module comprises coupling using quick change connectors.

8. The method of claim 1, wherein automatically coupling the stringer interface module to the vacuum control module comprises magnetically coupling the stringer interface module to the vacuum control module.

9. The method of claim 1, wherein automatically coupling the stringer interface module to the vacuum control module comprises controlling a rotary locking mechanism by the end effector to couple the stringer interface module to the vacuum control module.

10. A method of placing a composite member comprising:
automatically coupling a stringer interface module to a vacuum control module of an end effector;
placing a composite member in contact with a forming surface of a forming tool using the end effector while sending vacuum through the vacuum control module to a first region of the stringer interface module;
compacting the composite member against the forming tool by sending vacuum through the vacuum control module to a second region of the stringer interface module; and
automatically removing the stringer interface module from the vacuum control module after compacting the composite member against the forming tool.

11. The method of claim 10 further comprising:
automatically coupling a second stringer interface module having a different contact surface shape than the stringer interface module to the vacuum control module of the end effector.

12. The method of claim 10, wherein automatically coupling the stringer interface module to the vacuum control module comprises coupling using quick change connectors.

13. The method of claim 10, wherein automatically coupling the stringer interface module to the vacuum control module comprises magnetically coupling the stringer interface module to the vacuum control module.

14. The method of claim 10, wherein automatically coupling the stringer interface module to the vacuum control module comprises controlling a rotary locking mechanism by the end effector to couple the stringer interface module to the vacuum control module.

15. A vacuum compactor configured to pick and place composite members of different cross-sections comprising:
a vacuum control module;
a number of releasable connectors associated with the vacuum control module actuatable by an end effector comprising the vacuum control module; and
a stringer interface module having a contact surface shape complementary to a composite member, configured to pick, place, and compress the composite member, and removably connectable to the vacuum control module by an end effector using the number of releasable connectors.

16. The vacuum compactor of claim 15, wherein the vacuum control module comprises a first region and a second region controllable to provide vacuum to different regions of the stringer interface module.

17. The vacuum compactor of claim 15, wherein the stringer interface module comprises a first region configured to lift a composite member, and a second region configured to compact the composite member.

18. The vacuum compactor of claim 17, wherein the stringer interface module comprises a raised face for an inlet of the second region.

19. The vacuum compactor of claim 15, wherein the number of releasable connectors comprises at least one of quick change connectors, magnets, or a rotary locking mechanism.

20. The vacuum compactor of claim 15, wherein the contact surface shape is complementary to a composite member having a hat-shaped cross-section.

21. A method of configuring an end effector comprising:
determining a stringer interface module to mate with a composite member having a cross-sectional shape; and
automatically coupling the stringer interface module to a vacuum control module of the end effector.

22. The method of claim 21 further comprising:
selecting the stringer interface module from a plurality of stringer interface modules having varied contact surface shapes.
